(19) United States
(12) Patent Application Publication
(10) Pub. No.: US 2026/0302064 A1
(43) Pub. Date: Oct. 1, 2026

(54) MULTILAYER CERAMIC CAPACITOR

(71) Applicant: TAIYO YUDEN CO., LTD., Tokyo (JP)

(72) Inventor: Ryo ITO, Tokyo (JP)

(21) Appl. No.: 19/552,222

(22) Filed: Feb. 27, 2026

(30) Foreign Application Priority Data
Mar. 26, 2025 (JP) 2025-052456

(51) Int. Cl. H01G 4/12; H01G 4/30

(52) U.S. Cl. CPC H01G 4/1227; H01G 4/30

(57) ABSTRACT

A multilayer ceramic capacitor includes an element body in which dielectric layers and internal electrode layers are alternately laminated in a first axis direction, in which the dielectric layers include: ceramic particles containing a perovskite compound represented by a general formula ABO3; silicon; and a rare-earth element, the perovskite compound contains titanium, an amount of the silicon is 3 atomic % or more relative to a total amount of the titanium, and the multilayer ceramic capacitor satisfies Expression I,

$$0.3 \leq Ly / Ln < 35 \qquad Expression I$$

where Ln is a distance (μm) between the internal electrode layers, and Ly is an average distance (nm) between the ceramic particles contained in a region where Ra(x)≥2Ra(0).

### CROSS-REFERENCE TO RELATED APPLICATIONS

This application is based upon and claims priority to Japanese Patent Application No. 2025-052456 filed on Mar. 26, 2025, the entire contents of which are incorporated herein by reference.

### BACKGROUND OF THE INVENTION

### 1. Field of the Invention

The present disclosure relates to a multilayer ceramic capacitor.

### 2. Description of the Related Art

A multilayer ceramic capacitor (MLCC) has a structure in which dielectric layers and internal electrode layers are alternately laminated. Such multilayer ceramic capacitors are used in various electronic devices, such as mobile phones and personal computers.

In recent years, as electronic devices using multilayer ceramic capacitors have become increasingly multifunctional and higher in performance, there has been a demand for multilayer ceramic capacitors with a longer lifetime and a higher capacitance. To meet such a demand, a multilayer ceramic capacitor has been proposed in which a large amount of rare-earth elements for prolonging the lifetime is contained in dielectric layers.

For example, Japanese Patent Application Laid-Open Publication No. 2023-021997 discloses a multilayer ceramic capacitor in which a main component of a dielectric layer is a ceramic material having, as a main phase, a perovskite structure represented by a general formula ABO₃ and containing rare-earth elements at both an A site and a B site for the purpose of realizing high reliability.

In recent years, in order to reduce environmental load, man-hours, cost, and the like, methods for manufacturing multilayer ceramic capacitors by firing at a low temperature have been developed. However, in the multilayer ceramic capacitor containing rare-earth elements as described above, when low-temperature firing is performed and the rare-earth element content is reduced in order to further reduce environmental load, man-hours, cost, and the like, the insulating property of the ceramic material in the dielectric layer deteriorates, which possibly shortens the lifetime and reduces reliability. Accordingly, further improvement has been desired. That is, in low-temperature-fired multilayer ceramic capacitors containing rare-earth elements, there has been a demand for the development of multilayer ceramic capacitors that achieve both a long lifetime and high capacitance, which is a fundamental performance requirement of such capacitors.

### SUMMARY OF THE INVENTION

According to an aspect of the present disclosure, a multilayer ceramic capacitor includes:
an element body in which dielectric layers and internal electrode layers are alternately laminated in a first axis direction, in which
the dielectric layers include: ceramic particles containing a perovskite compound represented by a general formula ABO₃; silicon; and a rare-earth element,
the perovskite compound contains titanium,
an amount of the silicon is 3 atomic % or more relative to a total amount of the titanium, and
the multilayer ceramic capacitor satisfies Expression I,

$$0.3 \leq Ly / Ln < 35 \qquad Expression I$$

where Ln is a distance (μm) between the internal electrode layers, and Ly is an average distance (nm) between the ceramic particles contained in a region where Ra(x)≥2Ra(0), in which Ra is a ratio of the amount of the silicon (atomic %) to an amount of the rare-earth element (atomic %), Ra(0) is an average value of Ra in the dielectric layers interposed between the internal electrode layers, and Ra(x) is a value of the Ra at a desired position in the dielectric layers interposed between the internal electrode layers.

### BRIEF DESCRIPTION OF THE DRAWINGS

FIG. 1 is a perspective view showing a multilayer ceramic capacitor according to an embodiment of the present disclosure;

FIG. 2 is a cross-sectional view taken along a line A-A in FIG. 1;

FIG. 3 is a cross-sectional view taken along a line B-B in FIG. 1;

FIG. 4A is an enlarged schematic view of a region C in FIG. 2;

FIG. 4B is a schematic view illustrating an example of a distance Ly between ceramic particles;

FIG. 5A is a schematic view illustrating an example of triple junctions and a region subjected to TEM-EDX analysis in the multilayer ceramic capacitor according to a present embodiment;

FIG. 5B is an example of a graph created based on results of the TEM-EDX analysis in FIG. 5A; and

FIG. 6 is a flowchart illustrating a method for manufacturing a multilayer ceramic capacitor according to an embodiment.

### DESCRIPTION OF THE EMBODIMENTS

The present disclosure provides a multilayer ceramic capacitor that exhibits excellent lifetime and electrostatic capacitance on the premise of low-temperature firing.

Hereinafter, embodiments of the present disclosure will be described in detail. Each embodiment may hereinafter be referred to as “the present embodiment”; however, the present disclosure is not limited thereto. In this specification and the drawings, components having substantially the same functional configurations are denoted by the same reference signs, and repeated descriptions thereof may be omitted. In the drawings, mutually orthogonal x-axis, y-axis, and z-axis are shown as appropriate. The x-axis, the y-axis, and the z-axis define a fixed coordinate system for a multilayer ceramic capacitor. When a multilayer ceramic capacitor, an example of a multilayer ceramic electronic component, has a substantially rectangular parallelepiped external shape, the x-axis, the y-axis, and the z-axis may correspond to the length, width, and height of the multilayer ceramic capacitor, respectively.

The multilayer ceramic capacitor according to the present embodiment includes an element body in which dielectric layers and internal electrode layers are alternately laminated in a first axis direction, in which the dielectric layers include: ceramic particles containing a perovskite compound represented by a general formula ABO₃; silicon; and a rare-earth element, the perovskite compound contains titanium, an amount of the silicon is 3 atomic % or more relative to a total amount of the titanium, and the multilayer ceramic capacitor satisfies Expression I,

$$0.3 \leq Ly / Ln < 35 \qquad Expression I$$

where Ln is a distance (μm) between the internal electrode layers, and Ly is an average distance (nm) between the ceramic particles contained in a region where Ra(x)≥2Ra(0), in which Ra is a ratio of the amount of the silicon (atomic %) to an amount of the rare-earth element (atomic %), Ra(0) is an average value of Ra in the dielectric layers interposed between the internal electrode layers, and Ra(x) is a value of the Ra at a desired position in the dielectric layers interposed between the internal electrode layers.

### [Basic Structure of Multilayer Ceramic Capacitor]

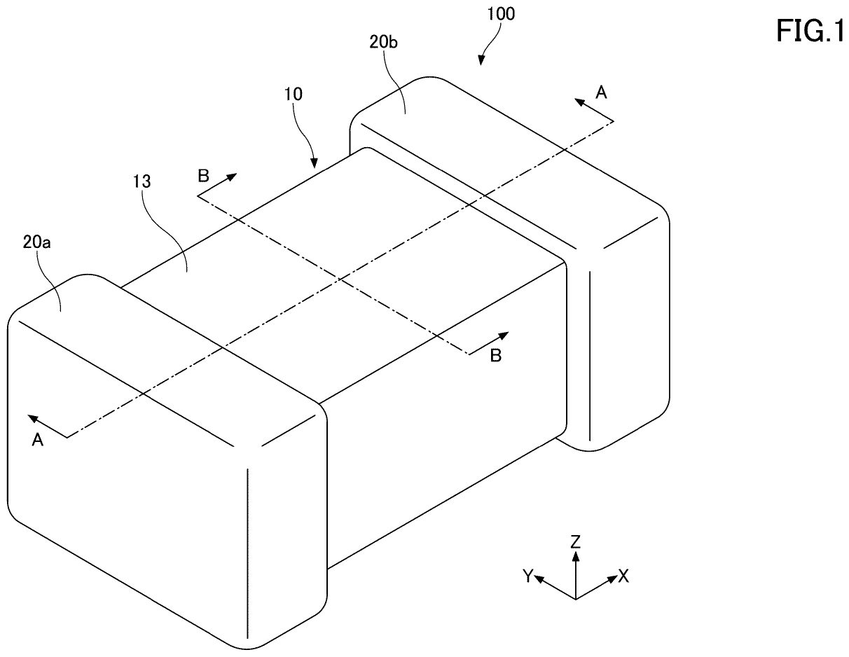

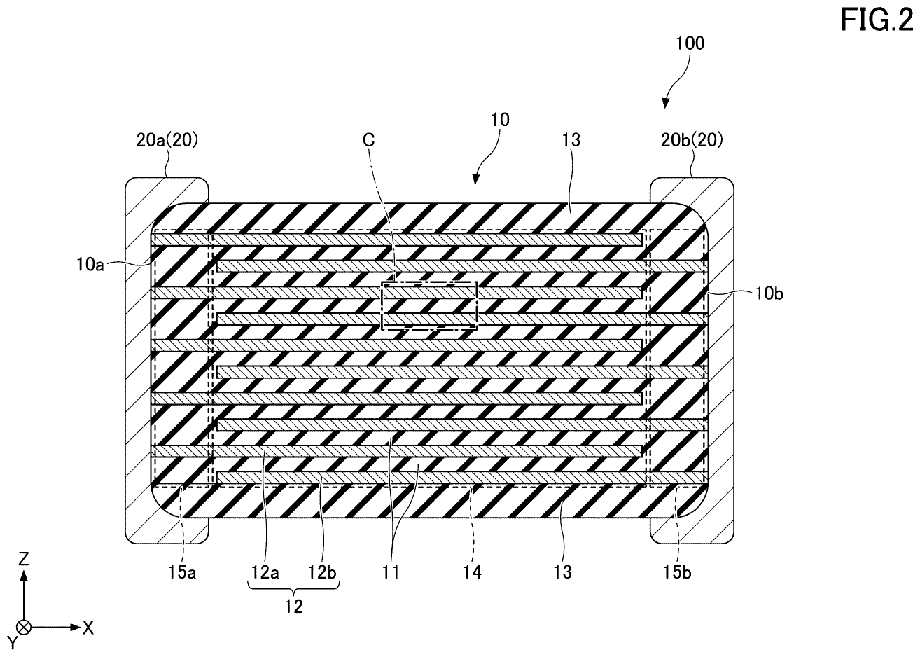

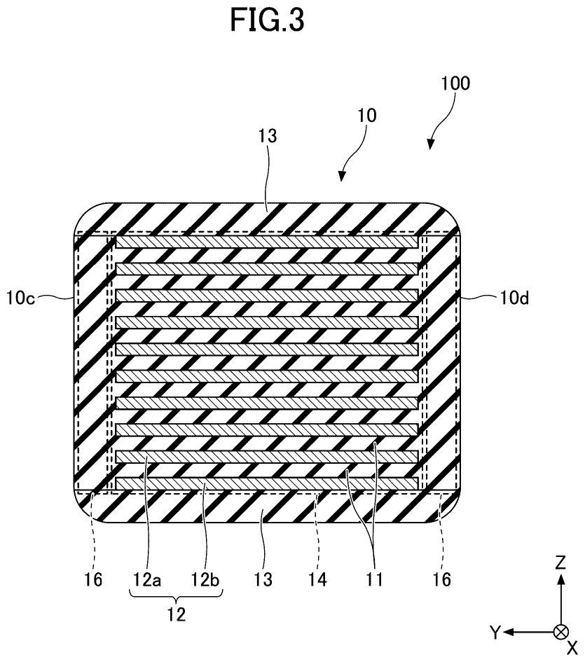

FIG. 1 is a perspective view showing a multilayer ceramic capacitor 100 according to an embodiment of the present disclosure. FIG. 2 is a cross-sectional view taken along a line A-A in FIG. 1. FIG. 3 is a cross-sectional view taken along a line B-B in FIG. 1.

As shown in FIGS. 1 to 3, a multilayer ceramic capacitor 100 includes an element body 10 having a substantially rectangular parallelepiped shape. In the element body 10, two opposing surfaces are referred to as a top surface and a bottom surface, and four surfaces connecting the top surface and the bottom surface are each referred to as a side surface. Typically, the surface facing a circuit board when the multilayer ceramic capacitor is mounted thereon is referred to as the bottom surface; however, the bottom surface is not limited thereto.

In an example shown in FIGS. 1 to 3, a first external electrode 20a and a second external electrode 20b are provided on a first side surface 10a and a second side surface 10b (see FIG. 2), respectively, which are two opposing side surfaces of the element body 10.

The first external electrode 20a extends from the first side surface 10a to four surfaces adjacent to the first side surface 10a. The second external electrode 20b extends from the second side surface 10b to four surfaces adjacent to the second side surface 10b. The first external electrode 20a and the second external electrode 20b are spaced apart from each other. The external electrodes may be provided on surfaces of the element body 10 other than the two opposing side surfaces.

The element body 10 includes dielectric layers 11 and internal electrode layers 12 alternately laminated in a first axis direction. The dielectric layers 11 contain acicular particles and a ceramic material that functions as a dielectric.

The internal electrode layers 12 include a plurality of first internal electrode layers 12a and a plurality of second internal electrode layers 12b. The first internal electrode layers 12a and the second internal electrode layers 12b are alternately laminated in the first axis direction. The end edges of the first internal electrode layers 12a are extended to the surface of the element body 10 on which the first external electrode 20a is provided, that is, the first side surface 10a in FIGS. 1 to 3. The end edges of the second internal electrode layers 12b are extended to the surface of the element body 10 on which the second external electrode 20b is provided, that is, the second side surface 10b in FIGS. 1 to 3. Accordingly, the first internal electrode layers 12a and the second internal electrode layers 12b, which are alternately laminated, are electrically connected to the first external electrode 20a and the second external electrode 20b, respectively. Thus, the multilayer ceramic capacitor 100 has a laminated structure in which a plurality of capacitor elements are formed. Note that the number of dielectric layers 11 and the number of internal electrode layers 12 in FIGS. 1 to 3 are merely examples for facilitating the explanation, and the multilayer ceramic capacitor according to the present embodiment may include a larger number of laminated layers.

The laminating direction in which the dielectric layers 11 and the internal electrode layers 12 are laminated is the first axis direction. As shown in FIGS. 1 to 3, when the first axis direction, which is the laminating direction, corresponds to a direction along the Z-axis (Z-axis direction) in a fixed coordinate system, the Z-axis defines the laminating direction of the dielectric layers 11 and the internal electrode layers 12, and also defines a direction in which the internal electrode layers 12 oppose each other.

An axis perpendicular to the first axis, which is the laminating direction, is referred to as a second axis. As shown in FIGS. 1 to 3, when the second axis perpendicular to the first axis (the laminating direction) corresponds to a direction along the X-axis (X-axis direction), the X-axis defines a direction in which the internal electrode layers 12 are led out, and also defines a direction in which the first side surface 10a and the second side surface 10b of the element body 10 oppose each other, or a direction in which the first external electrode 20a and the second external electrode 20b oppose each other. In the example shown in FIGS. 1 to 3, the electrode led-out direction (X-axis direction) corresponds to a direction along a longitudinal direction of the element body 10.

An axis perpendicular to both the first axis (the laminating direction) and the second axis is referred to as a third axis. As shown in FIGS. 1 to 3, when a third axis perpendicular to both the first axis (the laminating direction) and the second axis corresponds to a direction along the Y-axis (Y-axis direction), the Y-axis defines a direction in which a third side surface 10c and a fourth side surface 10d of the four side surfaces of the element body 10 oppose each other. In the example shown in FIGS. 1 to 3, the Y-axis direction corresponds to a direction along a width direction of the element body 10.

The X-axis direction, the Y-axis direction, and the Z-axis direction are orthogonal to one another. The laminating direction is not limited to the Z-axis direction, and may be set to any axis direction. Accordingly, for example, the first axis serving as the laminating direction may be the X-axis that defines the X-axis direction or the Y-axis that defines the Y-axis direction.

In this specification, drawings illustrating, as an example, a specific embodiment may be used for describing general embodiments. However, descriptions given with reference to a coordinate axis system used in such a specific embodiment are to be understood as being applicable to a general coordinate system in which the laminating direction is defined as the first axis in the general embodiments. For example, in FIGS. 1 to 3, which illustrate a specific embodiment in which the laminating direction coincides with the Z-axis direction, the X-axis, the Y-axis, and the Z-axis may be read as the second axis, the third axis, and the first axis, respectively, in the general embodiments.

A region in which the first internal electrode layers 12a connected to the first external electrode 20a and the second internal electrode layers 12b connected to the second external electrode 20b oppose each other is referred to as a capacitance portion 14. The capacitance portion 14 is a region in which electric capacitance is generated in the multilayer ceramic capacitor 100. In other words, the capacitance portion 14 is a region in which the internal electrode layers, which are connected to different external electrodes and adjacent to each other with a dielectric layer interposed therebetween, oppose each other.

Outermost layers of the capacitance portion 14, which is formed by laminating the dielectric layers 11 and the internal electrode layers 12, are the internal electrode layers 12 in the laminating direction (Z-axis direction). Cover layers 13 may be disposed on outer surfaces of the capacitance portion 14 in the laminating direction, that is, on outer surfaces of the outermost internal electrode layers 12 in the laminating direction.

The cover layers 13 are layers containing a ceramic material that functions as a dielectric, and may have the same composition as the dielectric layers 11 or may have a different composition.

The configuration of the element body 10 is not limited to those shown in FIGS. 1 to 3 provided that the first internal electrode layers 12a and the second internal electrode layers 12b are exposed at different regions of the surfaces of the element body 10 and are electrically connected to different external electrodes. The different regions of the surfaces of the element body 10 may be surface regions of the surfaces opposing each other among the surfaces of the element body 10, may be surface regions of surfaces adjacent to each other, or may be different surface regions of one surface. Provided that the different external electrodes are spaced apart from each other, the first internal electrode layers 12a and the second internal electrode layers 12b may extend from surfaces, on which the first internal electrode layers 12a and the second internal electrode layers 12b are exposed at the surface regions, to other surfaces of the multilayer body.

A region in which the first internal electrode layers 12a connected to the first external electrode 20a oppose each other in the laminating direction without the second internal electrode layers 12b connected to the second external electrode 20b interposed therebetween is referred to as a first end margin 15a. A region in which the second internal electrode layers 12b connected to the second external electrode 20b oppose each other in the laminating direction without the first internal electrode layers 12a connected to the first external electrode 20a interposed therebetween is referred to as a second end margin 15b. Each end margin is a region in which the internal electrode layers connected to the same external electrode oppose each other in the laminating direction without the internal electrode layers connected to a different external electrode interposed therebetween. The first end margin 15a and the second end margin 15b are regions in which no electric capacitance is generated.

As shown in FIG. 3, regions provided adjacent to outer sides of the capacitance portion 14 in the Y-axis direction are referred to as side margins 16. The side margins 16 are outer regions adjacent to the sides of the capacitance portion 14 on which the internal electrode layers 12 are not led out. The side margins 16 are regions in which no electric capacitance is generated.

The size of the multilayer ceramic capacitor 100 is not particularly limited and may be selected as appropriate depending on the intended purpose. For example, the multilayer ceramic capacitor 100 may have: a length of 0.25 mm, a width of 0.125 mm, and a height of 0.125 mm; a length of 0.4 mm, a width of 0.2 mm, and a height of 0.2 mm; a length of 0.6 mm, a width of 0.3 mm, and a height of 0.3 mm; a length of 1.0 mm, a width of 0.5 mm, and a height of 0.5 mm; a length of 3.2 mm, a width of 1.6 mm, and a height of 1.6 mm; or a length of 4.5 mm, a width of 3.2 mm, and a height of 2.5 mm. However, the above-described sizes of the multilayer ceramic capacitor 100 are merely examples, and the multilayer ceramic capacitor 100 is not limited to these sizes.

The size of the multilayer ceramic capacitor 100 may be, for example, such that the length is greater than the width, which is equal to or greater than the height; the width is greater than the length, which is equal to or greater than the height; the height is greater than the length, which is equal to or greater than the width; or the height is greater than the width, which is equal to or greater than the length. Note that, in the multilayer ceramic capacitor 100 shown in FIGS. 1 to 3, the length is defined along the X-axis direction (the electrode led-out direction), the width is defined along the Y-axis direction, and the height is defined along the Z-axis direction (the laminating direction).

### (Dielectric Layer)

The dielectric layers 11 include: ceramic particles containing a perovskite compound represented by a general formula ABO₃; silicon; and a rare-earth element, and may further include an additional component as necessary.

### <Ceramic Particles>

The dielectric layers 11 include ceramic particles containing, as a main component, a compound having a perovskite structure represented by the general formula ABO₃ (also referred to as a perovskite compound). Note that, in this specification, the expression “containing a predetermined component as a main component” means that the predetermined component is present in the largest amount among the components contained.

The perovskite compound content of the dielectric layers 11 is not particularly limited and may be selected as appropriate depending on the intended purpose. For example, the perovskite compound may be contained in an amount of 50 atomic % or more, 60 atomic % or more, 80 atomic % or more, 90 atomic % or more, or 95 atomic % or more. Note that the perovskite structure may be oxygen-deficient relative to a stoichiometric composition. That is, the perovskite compound may be represented by ABO_{3-α}, where 0≤α≤1, and α represents a deviation from the stoichiometric composition.

The perovskite compound is not particularly limited and may be selected as appropriate depending on the intended purpose, provided that the perovskite compound contains titanium. Examples of the perovskite compound include one or more compounds selected from barium titanate (BaTiO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z<1), which form a perovskite structure.

Specific examples of the compound represented by Ba_{1-x-y}CaₓSr_{y}Ti_{1-z}Zr_{z}O₃ include barium strontium titanate, barium calcium titanate, barium zirconate titanate, calcium zirconate titanate, and barium calcium zirconate titanate.

Among these perovskite compounds, barium titanate (BaTiO₃) is preferable in terms of excellent dielectric properties, such as a high dielectric constant and a low dielectric loss. When the dielectric layers 11 contain barium titanate as the perovskite compound, the electrostatic capacitance of the multilayer ceramic capacitor 100 can be increased. The ceramic material of the dielectric layers 11 preferably contains barium titanate as the main component, and may be composed solely of barium titanate.

Barium titanate can generally be produced by reacting a titanium source (e.g., titanium dioxide) with a barium source (e.g., barium carbonate).

A method for synthesizing a ceramic powder serving as ceramic particles that constitute the main component of the dielectric layers 11 is not particularly limited and may be selected as appropriate depending on the intended purpose. For example, the method may include a solid-phase method, a sol-gel method, and a hydrothermal method.

### <Silicon (Si)>

The dielectric layers 11 include silicon (Si). Silicon is contained to improve the lifetime of the multilayer ceramic capacitor. Since silicon also functions as a sintering aid, the multilayer ceramic capacitor material can be sintered at a low temperature (e.g., 1200° C. or less). By sintering the multilayer ceramic capacitor material at a low temperature, it is possible to minimize a decrease in the lifetime of the multilayer ceramic capacitor that could occur due to a decrease in the amount of the rare-earth element. Although the details will be described later, when silicon is included in the dielectric layers 11 interposed between the internal electrode layers 12a and the internal electrode layers 12b, the surface of each ceramic particle is coated with a silicon-derived glass phase, and thus higher insulation properties can be provided.

A method for adding silicon to the dielectric layers 11 is not particularly limited and may be selected as appropriate depending on the intended purpose. In order to facilitate coating of the entire surface of each ceramic particle, a preferable method is to immerse the ceramic particles in a silicon-containing solution and then subject the ceramic particles to heat treatment.

The silicon-containing solution is not particularly limited and may be selected as appropriate depending on the intended purpose, provided that the silicon-containing solution is capable of coating the surfaces of the ceramic particles with silicon. For example, the silicon-containing solution may include a colloidal silica solution and a silica nanoparticle dispersion.

The silicon concentration of the silicon-containing solution is not particularly limited and may be selected as appropriate depending on the intended purpose. For example, the silicon concentration may range from 0.2 mass % to 5 mass %, inclusive.

The immersion conditions of the ceramic particles in the silicon-containing solution are not particularly limited and may be selected as appropriate depending on the intended purpose. For example, the immersion may be performed at 60° C. for 10 minutes to 360 minutes, preferably at 60° C. for 10 minutes to 100 minutes. When the immersion time of the ceramic particles in the silicon-containing solution is 360 minutes or less, a ratio Ry described later is easily adjusted to less than 35, and the electrostatic capacitance of the multilayer ceramic capacitor can be ensured. When the immersion time of the ceramic particles in the silicon-containing solution is 10 minutes or more, the ratio Ry described later is easily adjusted to 0.3 or more, and the lifetime of the multilayer ceramic capacitor can be ensured.

The heat treatment conditions after the immersion of the ceramic particles in the silicon-containing solution are not particularly limited and may be selected as appropriate depending on the intended purpose. For example, the heat treatment may be performed at a low temperature from 750° C. to 1,000° C. for 2 hours to 10 hours.

The silicon-containing solution may be obtained by synthesis as appropriate, or may be a commercially available product. Examples of the commercially available product include colloidal silica (available from Fuso Chemical Co., Ltd.), NexSil 12HS (colloidal silica, available from NYACOL Nanotechnologies Co., Ltd.), and silica nanoparticle dispersion (available from Nippon Shokubai Co., Ltd.).

A more specific example of the method for adding silicon to the dielectric layers 11 is as follows. Ceramic particles are immersed in a colloidal silica solution containing a desired amount of SiO₂, which has been diluted with an additional solvent (e.g., distilled water). Thereafter, the silicon-containing solution and the ceramic particles are dried together at 100° C. to obtain ceramic particles having silicon compound particles attached to the surfaces of the ceramic particles. By subjecting the ceramic particles to heat treatment, ceramic particles whose surfaces are coated with silicon compounds can be obtained.

The additional solvent is not particularly limited and may be selected as appropriate depending on the intended purpose. When colloidal silica dispersed in a hydrophobic organic solvent is used as the solvent, the additional solvent is preferably the same organic solvent.

The additional solvent is not particularly limited and may be selected as appropriate depending on the intended purpose. For example, the addition amount of the additional solvent may be 1.5 times to 3 times the total mass of the ceramic particles.

The silicon content of the dielectric layers 11 interposed between the internal electrode layers 12a and the internal electrode layers 12b is 3 atomic % or more relative to the total amount of titanium contained in the dielectric layers 11 interposed between the internal electrode layers 12a and the internal electrode layers 12b. When the silicon content of the dielectric layers 11 interposed between the internal electrode layers 12a and the internal electrode layers 12b is 3 atomic % or more relative to the total amount of titanium elements contained in the dielectric layers 11 interposed between the internal electrode layers 12a and the internal electrode layers 12b, the lifetime and the electrostatic capacitance of the multilayer ceramic capacitor are improved.

A method for measuring the silicon content of the dielectric layers 11 interposed between the internal electrode layers 12a and the internal electrode layers 12b is not particularly limited and may be selected as appropriate depending on the intended purpose. For example, in the element amount distribution obtained by laser ablation inductively coupled plasma mass spectrometry (LA-ICP-MS), the ratio of Si to all of the Ti contained in the dielectric layers 11 interposed between the internal electrode layers 12a and the internal electrode layers 12b may be defined as the silicon content of the dielectric layers 11 interposed between the internal electrode layers 12a and the internal electrode layers 12b. In the LA-ICP-MS, a central cross section of the multilayer ceramic capacitor can be irradiated with a laser beam having a diameter of 100 μm or the like to acquire average information on the cross section.

### <Rare-Earth Element>

The dielectric layers 11 include a rare-earth element. A rare-earth element is contained to improve the lifetime of the multilayer ceramic capacitor.

The rare-earth element is not particularly limited and may be selected as appropriate depending on the intended purpose. Examples of the rare-earth element include scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb). Among these, gadolinium (Gd), dysprosium (Dy), holmium (Ho), and ytterbium (Yb) are preferable to improve reliability.

The rare-earth element content of the dielectric layers 11 interposed between the internal electrode layers 12a and the internal electrode layers 12b is not particularly limited and may be selected as appropriate depending on the intended purpose. However, the rare-earth element content preferably ranges from 0.4 atomic % to 5.5 atomic %, inclusive, relative to the total amount of titanium elements contained in the dielectric layers 11 interposed between the internal electrode layers 12a and the internal electrode layers 12b.

The rare-earth element content of the dielectric layers 11 interposed between the internal electrode layers 12a and the internal electrode layers 12b is preferably 0.4 atomic % or more relative to the total amount of titanium elements contained in the dielectric layers 11 interposed between the internal electrode layers 12a and the internal electrode layers 12b to improve the lifetime of the multilayer ceramic capacitor. When the rare-earth element content of the dielectric layers 11 interposed between the internal electrode layers 12a and the internal electrode layers 12b is 5.5 atomic % or less relative to the total amount of titanium contained in the dielectric layers 11 interposed between the internal electrode layers 12a and the internal electrode layers 12b, it is possible to overcome disadvantages such as a decrease in the lifetime of the multilayer ceramic capacitor because if the content exceeds this level, low-temperature sintering becomes difficult and sufficient densification is not achieved.

A method for measuring the rare-earth element content of the dielectric layers 11 interposed between the internal electrode layers 12a and the internal electrode layers 12b is not particularly limited and may be selected as appropriate depending on the intended purpose. For example, the method may be the same as a method for measuring the silicon content of the dielectric layers 11 interposed between the internal electrode layers 12a and the internal electrode layers 12b.

The multilayer ceramic capacitor according to the present embodiment satisfies Expression I.

$$0.3 \leq Ly / Ln < 35 \qquad Expression I$$

where Ln is a distance (μm) between the internal electrode layers, and Ly is an average distance (nm) between the ceramic particles contained in a region where Ra(x)≥2Ra(0), in which Ra is a ratio of the silicon content (atomic %) to a rare-earth element content (atomic %), Ra(0) is an average value of Ra in the dielectric layers interposed between the internal electrode layers, and Ra(x) is a value of the Ra at a desired position in the dielectric layers interposed between the internal electrode layers.

When the multilayer ceramic capacitor according to the present embodiment satisfies Expression I, a surface of each ceramic particle is coated with a silicon-derived glass phase, and thus higher insulation properties can be provided. A portion of the dielectric layer 11 where the ceramic particles are in direct contact with each other has low insulation properties, and thus may cause a disadvantage of the multilayer ceramic capacitor. This disadvantage is more likely to arise as the multilayer ceramic capacitor has thinner layers. However, in the present embodiment, in the multilayer ceramic capacitor satisfying Expression I, the surface of each ceramic particle is coated with a silicon-derived glass phase as described above. Thus, higher insulation properties are ensured, and the lifetime and the reliability are improved.

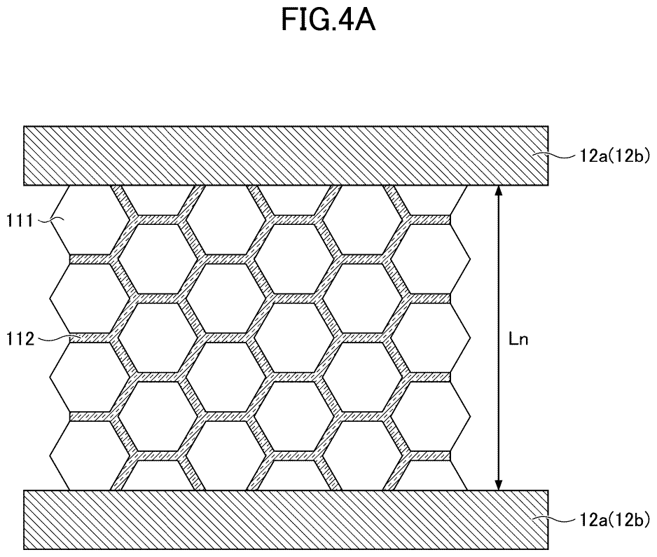

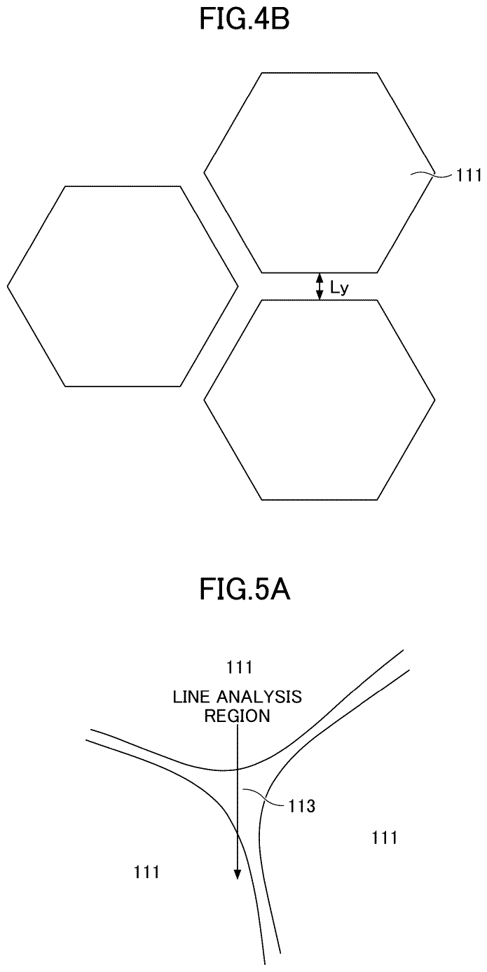

Herein, Expression I will be described more specifically with reference to FIGS. 4A and 4B. FIG. 4A is an enlarged schematic view of a region C in FIG. 2, and FIG. 4B is a schematic view illustrating an example of a distance Ly between ceramic particles.

In this specification, the phrase “distance Ln between the internal electrode layers 12” refers to a distance (μm) between the internal electrode layer 12a and the internal electrode layer 12b in a cross-sectional view of the multilayer ceramic capacitor taken along the first axis direction, as shown in FIG. 4A. Note that the cross-sectional view may be a YZ cross section as shown in FIG. 2, or may be an XZ cross section as shown in FIG. 3. Since the distance Ln between the internal electrode layers 12 corresponds to the thickness of the dielectric layer 11, Ln may be read as the thickness of the dielectric layer 11.

The distance Ln (μm) between the internal electrode layers 12 is not particularly limited and may be selected as appropriate depending on the intended purpose. However, the distance Ln preferably ranges from 0.2 μm to 4.0 μm, inclusive. When the distance Ln between the internal electrode layers 12 is 0.2 μm or more, it is possible to prevent the electrostatic capacitance from deteriorating due to the glass phase surrounding the ceramic particles. When the distance Ln between the internal electrode layers 12 is 4.0 μm or less, the influence of the glass phase surrounding the ceramic particles on the improvement of the insulation properties can be reduced.

A method for measuring the distance Ln (μm) between the internal electrode layers 12 is not particularly limited and may be selected as appropriate depending on the intended purpose. For example, the distance Ln may be evaluated based on cross-sectional observation of the multilayer ceramic capacitor 100. More specifically, the following method may be employed. The multilayer ceramic capacitor is polished along the X-axis direction or the Y-axis direction to expose a YZ plane or an XZ plane of the capacitance portion 14. In this case, the position of the plane exposed by polishing is preferably located near the center of the capacitance portion 14 in the X-axis direction or the Y-axis direction. An image of the exposed plane is captured by a laser microscope or the like, and approximately 5 to 10 dielectric layers 11 are selected from each of a central portion, an upper end portion, and a lower end portion in the Z-axis direction (the laminating direction of the dielectric layers 11), thereby selecting a total of approximately 15 to 20 dielectric layers 11. A thickness (a length in the Z-axis direction) of each dielectric layer 11 is measured at portions corresponding to ¼, ½, and ¾ of a dielectric layer width, and an average value of the measured thicknesses may be taken as the thickness of the dielectric layer 11, that is, the distance Ln (μm) between the internal electrode layers 12. When images are captured using a laser microscope or the like, the images may be captured separately for the central portion, the upper end portion, and the lower end portion in the Z-axis direction (the laminating direction of the dielectric layers 11). Alternatively, the images may be captured separately for portions corresponding to ¼, ½, and ¾ of the dielectric layer width.

In this specification, the phrase “distance Ly between the ceramic particles” refers to an average distance (nm) between ceramic particles 111 in the dielectric layers 11, as shown in FIG. 4B. The distance Ly between the ceramic particles 111 is an average distance (nm) between the ceramic particles 111 contained in a region where Ra(x)≥2Ra(0), in which Ra is a ratio of the silicon content (atomic %) to the rare-earth element content (atomic %), and Ra(0) is an average value of Ra in the dielectric layers 11 interposed between the internal electrode layers 12a and the internal electrode layers 12b. The region where the ratio Ra satisfies Ra(x)≥2Ra indicates a region where the ratio of the silicon content is high in the dielectric layers 11 interposed between the internal electrode layers 12a and the internal electrode layers 12b, and is a region where a thick silicon-derived glass phase 112 is present in the dielectric layers 11. When the ratio Ra satisfies Ra(x)≥2Ra, the insulation properties of the multilayer ceramic capacitor are further ensured, and thus the reliability is improved.

A method for identifying the region where the ratio Ra satisfies Ra(x)≥2Ra is not particularly limited and may be selected as appropriate depending on the intended purpose. For example, the following method may be employed. First, the silicon content (atomic %) and the rare-earth element content (atomic %) relative to the total amount of titanium elements contained in the dielectric layers 11 interposed between the internal electrode layers 12a and the internal electrode layers 12b are determined respectively by a method for measuring the silicon content of the dielectric layers 11 interposed between the internal electrode layers 12a and the internal electrode layers 12b and a method for measuring the rare-earth element content of the dielectric layers 11 interposed between the internal electrode layers 12a and the internal electrode layers 12b to calculate the ratio Ra. The dielectric layers 11 including the ceramic particles are analyzed by transmission electron microscope-energy dispersive X-ray spectroscopy (TEM-EDX), and a region where the ratio Ra satisfies Ra(x)≥2Ra is identified from the resulting mapping analysis information.

The distance Ly (nm) between the ceramic particles is not particularly limited and may be selected as appropriate depending on the intended purpose. However, the distance Ly preferably ranges from 0.3 nm to 30 nm, inclusive. When the distance Ly between the ceramic particles is 0.3 nm or more, the insulation properties of the multilayer ceramic capacitor are ensured, and thus the reliability is improved. When the distance Ly between the ceramic particles is 30 nm or less, the electrostatic capacitance of the multilayer ceramic capacitor is improved.

A method for measuring the distance Ly (nm) between the ceramic particles is not particularly limited and may be selected as appropriate depending on the intended purpose. For example, the distance Ly may be evaluated based on cross-sectional observation of the multilayer ceramic capacitor 100. More specifically, the following method may be employed. The multilayer ceramic capacitor is polished along the X-axis direction or the Y-axis direction to expose a YZ plane or an XZ plane of the capacitance portion 14. The exposed plane is then subjected to focused ion beam (FIB) processing to form a thin section. In this case, the position of the plane exposed by polishing and thinning is preferably located near the center of the capacitance portion 14 in the X-axis direction or the Y-axis direction. Images of three observation regions of the exposed surface are captured by a TEM or the like. In each observation region, TEM-EDS mapping analysis is performed on the region of the minimum distance between adjacent particles having an average particle size. Based on the mapping analysis, a line for line analysis is set, and line analysis is then performed. To select particles having an average particle size, the sizes of at least 200 particles are analyzed from a scanning electron microscope (SEM) photograph of the dielectric layers 11 of the same cross section by using image analysis software such as ImageJ, an average particle size Dₐᵥₑ is calculated, and particles having a particle size of Dₐᵥₑ±20% are defined as particles having the average size. In addition, for combinations of average-sized particles, a line is set based on mapping analysis information obtained using TEM-EDS, and line analysis is performed at a total of five points. The median of the distances between the ceramic particles at 15 points obtained from the three observation regions may be defined as the average distance Ly between the ceramic particles.

“Ly/Ln” in this specification may be referred to as a ratio Ry. The ratio Ry is 0.3 or more and less than 35, and preferably 10 or more and less than 30. In other words, the ratio Ry preferably satisfies Expression II.

$$10 \leq Ly / Ln < 30 \qquad Expression II$$

When the ratio Ry is 0.3 or more, the glass phase 112 covering each ceramic particle 111 is sufficiently thick. Thus, high insulation properties are provided, and the lifetime of the multilayer ceramic capacitor is improved. When the ratio Ry is less than 35, the glass phase 112 surrounding each ceramic particle 111 limits the solid solubility of the rare-earth element in the ceramic particles. Thus, the electrostatic capacitance of the multilayer ceramic capacitor is improved.

The ratio Ra(0) is preferably 0.55 or more and less than 7.5, and more preferably 3.0 or more and less than 6.0. When the ratio Ra(0) is 0.55 or more, the material of the multilayer ceramic capacitor can be sintered at a low temperature while achieving sufficient densification. Thus, the lifetime of the multilayer ceramic capacitor is improved. This is also advantageous in terms of reducing environmental load, man-hours, and cost. When the ratio Ra(0) is less than 7.5, a sufficient amount of the rare-earth element is ensured. Thus, the lifetime of the multilayer ceramic capacitor is improved.

### <Particles Containing Aluminum (Al)>

The dielectric layers 11 may include particles containing aluminum (Al). When the dielectric layers 11 include particles containing aluminum (Al), the glass phase 112 is modified by the aluminum, reducing the flowability of the glass phase 112. Thus, the glass phase 112 covering each ceramic particle 111 can be formed with an increased thickness.

The addition amount of particles containing aluminum (Al) is not particularly limited and may be selected as appropriate depending on the intended purpose. However, the addition amount may be adjusted, in consideration of the addition amounts of silicon and the rare-earth element, and the like, so as to satisfy Expression I.

The dielectric layers 11 may contain an additive in addition to the ceramic particles, silicon, rare-earth element, and particles containing aluminum (Al) described above. Such an additive is not particularly limited and may be selected as appropriate depending on the intended purpose. Examples of the additive include: an elemental substance or a compound containing one or more elements selected from zirconium (Zr), magnesium (Mg), manganese (Mn), molybdenum (Mo), vanadium (V), and chromium (Cr); an elemental substance or a compound containing one or more elements selected from cobalt (Co), nickel (Ni), lithium (Li), boron (B), sodium (Na), and potassium (K); and glass containing an oxide of one or more elements selected from cobalt, nickel, lithium, boron, sodium, and potassium.

The dielectric layers 11 may contain copper (Cu). When the dielectric layers 11 contain copper, the copper concentration in the dielectric layers 11 is preferably 0.1 atomic % or less to ensure the insulation properties of the dielectric layers 11.

### (Internal Electrode Layer)

The internal electrode layers 12 contain a metal or an alloy as a main component. For example, the internal electrode layers 12 may contain, as the main component, a base metal (e.g., nickel (Ni) or tin (Sn)), or an alloy including such a base metal. Note that the internal electrode layers 12 may contain, as the main component, a noble metal (e.g., platinum (Pt), palladium (Pd), silver (Ag), or gold (Au)), or an alloy including such a noble metal. Among these, the internal electrode layers 12 preferably contain Ni to provide excellent electrical characteristics while reducing cost.

The main component of the first internal electrode layers 12a and the main component of the second internal electrode layers 12b may be the same or different.

The internal electrode layers 12 may optionally contain an additional metal element in addition to the main component metal. When the internal electrode layers 12 contain an additional metal element, the additional metal element may be, for example, a metal more noble than the main component metal of the internal electrode layers 12. More specifically, one or more elements selected from the group consisting of Au (gold), Sn (tin), Cr (chromium), Y (yttrium), In (indium), As (arsenic), Co (cobalt), Cu (copper), Ir (iridium), Mg (magnesium), Os (osmium), Pd (palladium), Pt (platinum), Re (rhenium), Rh (rhodium), Ru (ruthenium), Se (selenium), Te (tellurium), W (tungsten), and Zn (zinc) may be contained. For example, the internal electrode layers 12 may contain copper (Cu). When the internal electrode layers 12 contain Ni as the main component, Cu may form an alloy with Ni. When the internal electrode layers 12 contain copper, the interfacial resistance between the internal electrode layers and the dielectric layers increases, thereby prolonging the lifetime of the MLCC.

The copper concentration (atomic %) in the internal electrode layers 12 is not particularly limited and may be selected as appropriate depending on the intended purpose. The copper concentration is preferably 2.5 atomic % or less, more preferably 2 atomic % or less, still more preferably 1.5 atomic % or less, and particularly preferably 1 atomic % or less. When the copper concentration (atomic %) in the internal electrode layer 12 is set to 2.5 atomic % or less as described above, it is possible to prevent a decrease in continuity of the internal electrode layers 12, which would otherwise be caused by a reduction in a melting point of the internal electrode layers 12 due to an excessive amount of copper present in the internal electrode layers 12. Moreover, the copper concentration (atomic %) in the internal electrode layers 12 is preferably 0.2 atomic % or more, more preferably 0.3 atomic % or more, and still more preferably 0.5 atomic % or more, to improve the lifetime characteristics.

A method for measuring the copper concentration in the internal electrode layers 12 is not particularly limited and may be selected as appropriate depending on the intended purpose. For example, the copper concentration may be defined as an average value of the copper concentration (atomic %) within a region corresponding to the internal electrode layers 12 in a concentration distribution graph obtained from TEM-EDX analysis. When strict delineation of the boundary is required, the region of the internal electrode layer 12 may be defined as a region in which an oxygen concentration is less than 5 atomic %. Herein, the copper concentration refers to an atomic ratio of copper to all elements contained in the internal electrode layers 12.

A thickness of the internal electrode layers 12 is not particularly limited and may be selected as appropriate depending on the intended purpose. The thickness preferably ranges from 0.1 μm to 1.5 μm, inclusive, and more preferably ranges from 0.3 μm to 1.0 μm, inclusive.

When the thickness of the internal electrode layers 12 is 0.1 μm or more, the functionality as internal electrodes can be ensured. When the thickness of the internal electrode layer 12 is 1.5 μm or less, the electrostatic capacitance can be increased without changing the external dimensions of the multilayer ceramic capacitor by increasing the number of laminated layers of the capacitance portion 14. In other words, it is preferable that the thickness of the internal electrode layers 12 be 1.5 μm or less to obtain a smaller multilayer ceramic capacitor while maintaining equivalent performance. To enable an increase in the electrostatic capacitance by increasing the number of laminated layers, the thickness of the internal electrode layers 12 is preferably 0.5 μm or less, and more preferably 0.4 μm or less.

A method for measuring the thickness of the internal electrode layers 12 is not particularly limited and may be selected as appropriate depending on the intended purpose. For example, the thickness of the internal electrode layers 12 may be measured by the same method used for measuring the thickness of the dielectric layers 11.

In the multilayer ceramic capacitor according to the present embodiment, a triple junction is preferably absent among the ceramic particles in the capacitance portion of the dielectric layers 11 interposed between the internal electrode layers 12a and the internal electrode layers 12b.

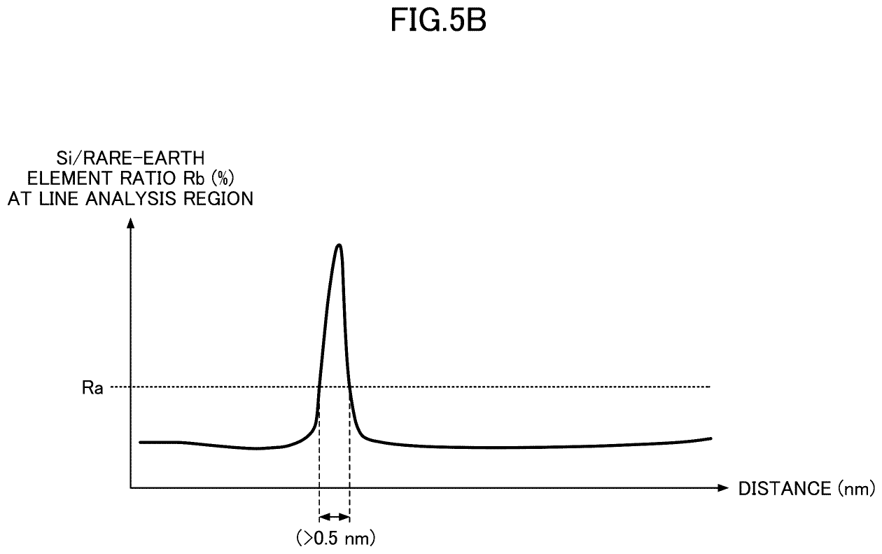

A more specific description will be given with reference to FIGS. 5A and 5B. FIG. 5A is a schematic view illustrating an example of a triple junction and a region subjected to TEM-EDX analysis in the multilayer ceramic capacitor according to a present embodiment, and FIG. 5B is an example of a graph created based on the results of the TEM-EDX analysis in FIG. 5A.

In this specification, the term “triple junction” refers to a grain boundary triple junction 113 among a plurality of ceramic particles, as shown in FIG. 5A.

In the multilayer ceramic capacitor of the present embodiment, a state “a triple junction is absent among the ceramic particles in the capacitance portion of the dielectric layers” is determined, for example, by the following method. First, as shown in FIG. 5A, three regions in the dielectric layers 11 along the first axis are set as observation regions by TEM-EDX, and mapping analysis is performed in each observation region. The mapping analysis data are stored, and a line is set at a portion to be analyzed based on the stored data to perform line analysis. The analysis line is preferably set so as to pass through substantially the center of a gap formed among at least three ceramic particles. In this case, the ceramic particles are preferably particles having an average particle size. A method for selecting the particles having an average particle size is as described in the method for measuring the distance Ly (nm) between the ceramic particles described above. Next, as shown in FIG. 5B, a graph is created from the distribution of the concentrations (atomic %) of the respective elements obtained from the line analysis, with the vertical axis representing “a ratio of the silicon content to the rare-earth element content at the line analysis region,” and the horizontal axis representing a “travel distance (nm) from the start point of the line analysis.” Note that the element ratio on the vertical axis is not the ratio Ra(0) in the dielectric layers 11 disposed between the internal electrode layers 12a and the internal electrode layers 12b, but the element ratio Ra(x) at the line analysis region. In this specification, the element ratio Ra(x) at the line analysis region may be referred to as Rb. In the graph, when the distance over which the ratio Rb at the line analysis region exceeds the ratio Ra(0) in the dielectric layers 11 interposed between the internal electrode layers 12a and 12b is 0.5 nm or more, the state is determined such that a triple junction is absent. Note that it is preferable that the line composition analysis using TEM-EDX be performed at a total of five points in each observation region for the combination of the particles having an average size, and that the presence or absence of a triple junction be determined based on the median of the ratios Rb at 15 points in total.

It is preferable that a triple junction be absent among the ceramic particles in the capacitance portion of the dielectric layers in the multilayer ceramic capacitor of the present embodiment because the glass phase 112 covering each ceramic particle 111 becomes sufficiently thick. Accordingly, high insulation properties are provided, and the lifetime of and the electrostatic capacitance of the multilayer ceramic capacitor are improved.

The physical properties of the multilayer ceramic capacitor of the present embodiment can be controlled by the coating conditions of the ceramic particles 111 in the silicon-containing solution, the heat treatment conditions after immersion in the silicon-containing solution, the addition amounts of silicon and the rare-earth element, and the like. The details of these conditions are as described above.

### [Method for Manufacturing Multilayer Ceramic Capacitor]

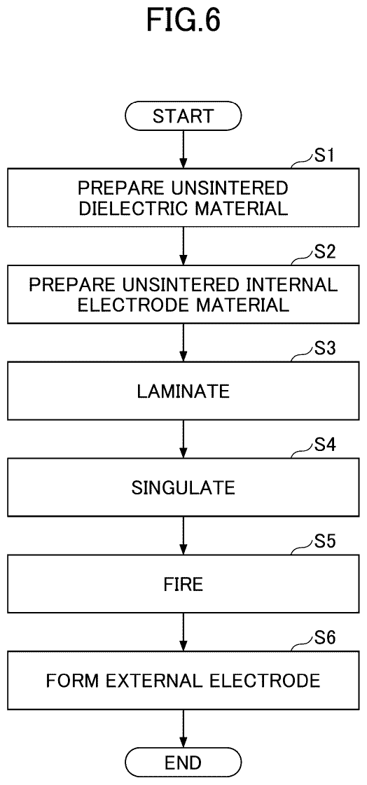

Next, a method for manufacturing the above-mentioned multilayer ceramic capacitor 100 will be described. FIG. 6 is a flowchart illustrating, as an example, a method for manufacturing the multilayer ceramic capacitor 100 according to an embodiment.

According to the present embodiment, a method for manufacturing a multilayer ceramic capacitor including an element body in which dielectric layers and internal electrode layers are alternately laminated in a first axis direction, and in which the dielectric layers include: ceramic particles containing a perovskite compound represented by a general formula ABO₃; silicon; and a rare-earth element, may be a method including: a lamination step of alternately laminating an unsintered dielectric material to form the dielectric layers and an unsintered internal electrode material to form the internal electrode layers to obtain a multilayer body; and a firing step of firing the multilayer body. In the method, the perovskite compound contains titanium, the silicon content is 3 atomic % or more relative to the total amount of titanium elements, and the multilayer ceramic capacitor satisfies Expression I.

$$0.3 \leq Ly / Ln < 35 \qquad Expression I$$

where Ln is a distance (μm) between the internal electrode layers, and Ly is an average distance (nm) between the ceramic particles contained in a region where Ra(x)≥2Ra(0), in which Ra is a ratio of the silicon content (atomic %) to a rare-earth element content (atomic %), Ra(0) is an average value of Ra in the dielectric layers interposed between the internal electrode layers, and Ra(x) is a value of the Ra at a desired position in the dielectric layers interposed between the internal electrode layers.

### (Preparation Step of Unsintered Dielectric Material (S1))

In a preparation step of an unsintered dielectric material (S1), a ceramic green sheet, which is an unsintered dielectric material to be fired into the dielectric layers 11, is prepared.

First, a dielectric-layer-forming powder is prepared. The dielectric-layer-forming powder includes ceramic particles, silicon; and a rare-earth element, and may further include particles containing aluminum as necessary. The ceramic particles are preferably Si-coated ceramic particles obtained by immersing the ceramic particles in a silicon-containing solution and then subjecting the ceramic particles to heat treatment, as described above.

A predetermined additive may be added to the dielectric-layer-forming powder depending on the intended purpose. The dielectric-layer-forming powder is wet-mixed with or without the additive, dried, and then pulverized. Thereafter, a binder (e.g., a polyvinyl butyral (PVB) resin), an organic solvent (e.g., ethanol and toluene), and a plasticizer are added and wet-mixed to prepare a dielectric-layer-forming slurry. The resulting dielectric-layer-forming slurry is applied onto a base such as a polyethylene terephthalate (PET) film by a die coater method, a doctor blade method, or the like, and then dried to obtain a ceramic green sheet (unsintered dielectric layer material).

In the method for manufacturing the multilayer ceramic capacitor according to the present embodiment, the addition amounts of the ceramic particles and the rare-earth element to the dielectric-layer-forming powder, the immersion conditions of the ceramic particles in the silicon-containing solution (e.g., silicon concentration, temperature, and time), and the heat treatment conditions of the ceramic particles after immersion in the silicon-containing solution (e.g., temperature and time) may be adjusted so as to satisfy Expression I. Accordingly, according to the present embodiment, the multilayer ceramic capacitor 100 with long lifetime and excellent electrostatic capacitance can be manufactured.

### (Preparation Step of Unsintered Internal Electrode Material (S2))

In a preparation step of an unsintered internal electrode material (S2), an unsintered internal electrode material to form the internal electrode layers 12, that is, the first internal electrode layers 12a and the second internal electrode layers 12b, is prepared. A metal serving as a main component of the unsintered internal electrode material may be the same metal material as that described above for the internal electrode layers 12 of the multilayer ceramic capacitor 100, and may be, for example, a base metal (e.g., Ni or Sn) or an alloy containing such metals. Alternatively, the metal material may be a noble metal (e.g., Pt, Pd, Ag, or Au), or an alloy containing such metals. Among these, the metal material preferably contains Ni and more preferably contains Ni as a main component to provide excellent electrical characteristics while reducing cost.

The metal material may optionally contain an additional metal element in addition to the main component metal. When the metal material contains an additional metal element, the additional metal element may be, for example, a metal more noble than the main component metal of the internal electrode layers 12. More specifically, one or more elements selected from the group consisting of Au (gold), Sn (tin), Cr (chromium), Y (yttrium), In (indium), As (arsenic), Co (cobalt), Cu (copper), Ir (iridium), Mg (magnesium), Os (osmium), Pd (palladium), Pt (platinum), Re (rhenium), Rh (rhodium), Ru (ruthenium), Se (selenium), Te (tellurium), W (tungsten), and Zn (zinc) may be contained. For example, when the main component metal of the internal electrode layers 12 is Ni, Cu may be added. Then, the metal material after the addition of Cu, an organic binder, and a solvent are kneaded to obtain a metal paste (unsintered internal electrode material). Note that Cu may be added after the metal paste is prepared from the main component metal material. Cu is preferably added in the form of an oxide during the firing step. Examples of the oxide of Cu include copper oxide.

A ceramic powder may be added as a co-material to the metal paste (unsintered internal electrode material). The main component of the ceramic powder is not particularly limited, but is preferably the same as that of the ceramic powder used in the preparation step of the unsintered dielectric material (Si). The ceramic powder may be added as a co-material during kneading of the metal paste.

### (Lamination Step (S3))

In a lamination step (S3), the resulting metal paste in the preparation step of the unsintered internal electrode material (S2) is printed on a surface of the ceramic green sheet obtained in the preparation step of the unsintered dielectric material (Si) by screen printing, gravure printing, or the like. Accordingly, a first internal electrode pattern to form the first internal electrode layer 12a and a second internal electrode pattern to form the second internal electrode layer 12b are arranged on the surface of the ceramic green sheet. Note that a method for forming the internal electrode patterns is not limited to printing, and may alternatively be performed by plating, vacuum deposition, sputtering, chemical vapor deposition (CVD), or the like using a mask.

The ceramic green sheet on which the metal paste has been applied is then laminated such that the internal electrode layers 12 are alternately led out to the pair of external electrodes 20a and 20b arranged in the longitudinal direction (X-axis direction) of the dielectric layers 11. This lamination may be performed by using a known technique. For example, in order to form the side margins 16, which are outer regions in the Y-axis direction in the capacitance portion 14, on the sides where the internal electrode layers 12 are not led out, an unsintered dielectric material may be arranged in peripheral regions in which the internal electrode patterns are not printed with the metal paste. The ceramic green sheet on which the metal paste is printed may be regarded as a lamination unit, and the number of lamination units may be, for example, from 100 layers to 500 layers.

Subsequently, a cover sheet, which is an unsintered cover material for forming cover layers, is laminated on the upper and lower sides of the multilayer body in which the ceramic green sheets and the internal electrode patterns are laminated, that is, on the opposite sides of the multilayer body in the laminating direction (Z-axis direction), to obtain a laminated assembly. The cover sheet may be formed mainly using a ceramic powder by the same method used for forming the unsintered dielectric material for the dielectric layers. Alternatively, the cover sheet may be formed from the same material as the unsintered dielectric material for forming the dielectric layers. The number of laminated cover sheets may be, for example, from 2 layers to 10 layers on each side.

The resulting laminated assembly is pressed in the laminating direction (Z-axis direction) to obtain a pressed body.

### (Singulation Step (S4))

The pressed body may be cut into individual pieces having a predetermined size by dicing using a dicer, laser cutting, or the like. A singulation method can employ a known technique as appropriate.

### (Firing Step (S5))

In a firing step (S5), the individual pieces of the laminated assembly are fired. The firing conditions are not particularly limited and may be selected as appropriate depending on the intended purpose. However, the hydrogen concentration preferably ranges from 0.03 vol % to 1.0 vol %, inclusive, and more preferably ranges from 0.05 vol % to 0.3 vol %. Note that the remainder of the reducing atmosphere, other than hydrogen, is nitrogen or argon. In the firing step (S5), Cu added in advance to the unsintered materials segregates or diffuses at the interface, and an intermediate region is formed.

The firing temperature in the firing step (S5) preferably ranges from 1,000° C. to 1,200° C., inclusive, and more preferably ranges from 1,150° C. to 1,200° C., inclusive. The firing time in the firing step (S5) may range from 30 minutes to 10 hours, inclusive.

### (External Electrode Forming Step (S6))

In an external electrode forming step, the first external electrode 20a and the second external electrode 20b can be formed by plating or the like. Accordingly, the multilayer ceramic capacitor 100 described above is completed.

### EXAMPLES

Hereinafter, the present disclosure will be described more specifically based on Examples.

### Example 1

### [Production of Multilayer Ceramic Capacitor]

1000 g of barium titanate was immersed at 60° C. for 60 minutes in a solution obtained by diluting 19.3 g of a colloidal silica solution (NexSil 12HS, available from NYACOL Nanotechnologies Inc.) with 2000 mL of distilled water serving as an additional solvent, and then was dried at 100° C. and subjected to heat treatment at 800° C. for 120 minutes to form Si-coated ceramic particles. A polyvinyl butyral (PVB) resin, a solvent, a plasticizer, and a sintering aid powder that is a Si compound were added to a dielectric-layer-forming powder composed of the Si-coated ceramic particles and a rare-earth element, and the mixture was wet-mixed to prepare a ceramic slurry. The ceramic slurry was applied to onto a base film using a doctor blade to form a dielectric green sheet so that the thickness of the dielectric layer after sintering was 0.9 μm.

Cu was added to nickel powder in the form of copper oxide (CuO) powder and mixed to prepare a mixed powder. A polyvinyl butyral (PVB) resin, a solvent, and a plasticizer were added to the mixed powder and kneaded to obtain a metal paste for forming internal electrode layers. The metal paste was printed on the dielectric green sheet to form internal electrode layer patterns.

A multilayer body was formed by laminating 500 dielectric green sheets on which the metal paste was printed, with dielectric green sheets serving as cover layers arranged on opposite sides in the lamination direction.

The resulting multilayer body was pressed and then cut into a predetermined size to obtain singulated green chips. The resulting green chips were subjected to a debinding treatment in an N₂ atmosphere, and the metal paste serving as a base layer for external electrodes was applied by dipping. Subsequently, the green chips were placed in a firing furnace, and firing was performed for 10 minutes while raising the temperature of the firing furnace (firing temperature) to 1,200° C. in an atmosphere having an H₂ concentration of 0.1 vol % and an N₂ concentration of 99.9 vol %. After firing, external electrodes were formed on the green chips by plating to obtain multilayer ceramic capacitors (MLCCs) having dimensions of 1.0 mm×0.5 mm×0.5 mm.

### [Measurement of Ratio Ra of Silicon to Rare-Earth Element in Dielectric Layers 11 Interposed Between Internal Electrode Layers 12a and Internal Electrode Layers 12b, and Calculation of Ra(0)]

The ratio of Si to the total Ti elements contained in the dielectric layers 11 interposed between the internal electrode layers 12a and the internal electrode layers 12b in the element distribution obtained by performing LA-ICP-MS on the element body of the multilayer ceramic capacitor was defined as the silicon content of the dielectric layers 11 interposed between the internal electrode layers 12a and the internal electrode layers 12b. Similarly, the rare-earth element content of the dielectric layers 11 interposed between the internal electrode layers 12a and the internal electrode layers 12b was calculated. Using the obtained element contents, Ra(0), which is the ratio Ra of the silicon content (atomic %) to the rare-earth element content (atomic %) of the dielectric layers 11 interposed between the internal electrode layers 12a and the internal electrode layers 12b, was calculated. The results are shown in Table 1.

### [Measurement of Distance Ln Between Internal Electrode Layers]

The multilayer ceramic capacitor was polished along the X-axis direction or the Y-axis direction to expose a YZ plane or an XZ plane of the capacitance portion 14. In this case, the position of the plane exposed by polishing was near the center of the capacitance portion 14 in the X-axis direction or the Y-axis direction. An image of the exposed plane was captured by a laser microscope, and approximately 5 to 10 dielectric layers 11 were selected from each of a central portion, an upper end portion, and a lower end portion in the Z-axis direction (the laminating direction of the dielectric layers 11), thereby selecting a total of approximately 15 to 20 dielectric layers 11. A thickness (a length in the Z-axis direction) of each dielectric layer 11 was measured at portions corresponding to ¼, ½, and ¾ of a dielectric layer width, and an average value of the measured thicknesses was defined as the thickness of the dielectric layer 11, that is, the distance Ln (μm) between the internal electrode layers 12. The results are shown in Table 1.

### [Measurement of Distance Ly Between Ceramic Particles and Calculation of Ry]

The multilayer ceramic capacitor was polished along the X-axis direction or the Y-axis direction to expose a YZ plane or an XZ plane of the capacitance portion 14. The exposed plane was then subjected to FIB processing to form a thin section. In this case, the position of the plane exposed by polishing and thinning was near the center of the capacitance portion 14 in the X-axis direction or the Y-axis direction. Images of three observation regions of the exposed surface were captured by an SEM. In each observation region, TEM-EDS mapping analysis was performed on the region of the minimum distance between adjacent particles having an average particle size. Based on the mapping analysis, a line for line analysis was set, and line analysis was then performed. To select particles having an average particle size, the sizes of at least 200 particles were analyzed from an SEM photograph of the dielectric layers 11 of the same cross section by Image J (image analysis software), an average particle size Dₐᵥₑ was calculated, and particles having a particle size of Dₐᵥₑ±20% were defined as particles having the average size. In addition, for combinations of average-sized particles, a line was set based on mapping analysis information obtained using TEM-EDS, and line analysis was performed at a total of five points. The median of the distances between the ceramic particles at 15 points obtained from the three observation regions was defined as the average distance Ly between the ceramic particles. The ratio Ry was calculated by dividing the obtained value of Ly by the value of Ln. The results are shown in Table 1.

### [Determination of Presence or Absence of Triple Junction]

Line analysis was performed on the dielectric layers of the multilayer ceramic capacitor along the first axis by TEM-EDX. The analysis line was set so as to pass through substantially the center of a gap formed among at least three ceramic particles. In this case, the ceramic particles were particles having an average particle size. A method for selecting the particles having an average particle size was as described in the method for measuring the distance Ly between the ceramic particles. The mapping analysis was performed, and a line for the line analysis was set based on the mapping analysis. A graph was created from the distribution of the concentrations (atomic %) of the respective elements obtained from the line analysis, with the vertical axis representing “an element ratio of silicon to the rare-earth element at the line analysis region,” and the horizontal axis representing a “travel distance (nm) from the start point of the line analysis.” In the graph, when the distance over which the ratio Rb at the line analysis region exceeds the ratio Ra(0) in the dielectric layers 11 interposed between the internal electrode layers 12a and the internal electrode layers 12b is 0.5 nm or more, the state was determined that a triple junction was absent. When the distance was less than 0.5 nm, the state was determined that a triple junction was present. Note that, for combinations of the particles having an average particle size, line analysis using TEM-EDS was performed at a total of five points in each of the three observation regions. The presence or absence of a triple junction was determined based on the median of the ratios Rb at 15 points obtained from the three observation regions. The results are shown in Table 1.

### [Evaluation of Lifetime Characteristics]

The lifetime characteristics were evaluated by a highly accelerated life test (HALT). A voltage of 22 V was applied at 125° C. to each of 20 produced multilayer ceramic capacitors, and a leakage current was measured over time. A time at which 50% of the samples reached a leakage current of 2,000 Å was recorded as the 50% HALT lifetime value. The results are shown in Table 1. Note that the lifetime of each multilayer ceramic capacitor is expressed relative to that of the multilayer ceramic capacitor of Comparative Example 1, which is defined as 100. A multilayer ceramic capacitor having a lifetime of 100% or more was determined to be acceptable. A multilayer ceramic capacitor having a lifetime of 300% or more was determined as “Excellent,” a multilayer ceramic capacitor having a lifetime of 100% or more and less than 300% was determined as “Good,” and other multilayer ceramic capacitors were determined as “Poor.”

### [Evaluation of Electrostatic Capacitance]

The electrostatic capacitance (F) of each produced multilayer ceramic capacitor was measured by using an LCR meter (HP4284A available from Keysight Technologies) under conditions of a voltage of 0.5 V and a frequency of 1 kHz. The results are shown in Table 1. Note that the electrostatic capacitance of each multilayer ceramic capacitor is expressed relative to that of the multilayer ceramic capacitor of Comparative Example 1, which is defined as 100. A multilayer ceramic capacitor having an electrostatic capacitance of 100% or more was determined to be acceptable. A multilayer ceramic capacitor having an electrostatic capacitance exceeding 100% was determined as “Excellent,” a multilayer ceramic capacitor having an electrostatic capacitance of 100% was determined as “Good,” and other multilayer ceramic capacitors were determined as “Poor.”

### Examples 2 to 9 and Comparative Examples 1 to 3

As shown in Table 1, each multilayer ceramic capacitor was produced and evaluated in the same manner as in Example 1, except that a composition of a dielectric-layer-forming powder was changed. Note that multilayer ceramic capacitors of Example 9 were produced by adding, to the material, a powder obtained by drying a colloidal silica solution alone without immersing barium titanate in the colloidal solution. The results are shown in Table 1.

TABLE 1

| | | | ELEMENT | | | | |
|---|---|---|---|---|---|---|---|
| | | | RATIO TO Ti | | | | |
| | | | IN DIELECTRIC | | | | DISTANCE |
| | COLLOIDAL | | LAYERS OF | | | DISTANCE | Ln |
| | SILICA | ADDITION | ELEMENT BODY | | | Ly | BETWEEN |
| | SOLUTION | OF DRIED | | RARE- | Ra (0) | BETWEEN | INTERNAL |
| | IMMERSION | COLLOIDAL | | EARTH | (Si/ | CERAMIC | ELECTRODE |
| | TIME | SILICA | Si | ELEMENT | RARE | PARTICLES | LAYERS |
| | [min] | POWDER | [at %] | [at %] | EARTH) | [nm] | [μm] |
| EXAMPLE 1 | 60 | — | 3.0 | 0.9 | 3.33 | 2.30 | 0.9 |
| EXAMPLE 2 | 120 | — | 5.0 | 0.9 | 5.56 | 11.2 | 0.9 |
| EXAMPLE 3 | 300 | — | 5.0 | 0.9 | 5.56 | 25.0 | 0.9 |
| EXAMPLE 4 | 360 | — | 5.0 | 0.9 | 5.56 | 28.7 | 0.9 |
| EXAMPLE 5 | 10 | — | 3.0 | 0.9 | 3.33 | 0.34 | 0.9 |
| EXAMPLE 6 | 60 | — | 3.0 | 4.5 | 0.67 | 2.73 | 0.9 |
| EXAMPLE 7 | 60 | — | 3.0 | 0.4 | 7.50 | 2.91 | 0.9 |
| EXAMPLE 8 | 60 | — | 3.0 | 5.5 | 0.55 | 2.30 | 0.9 |
| EXAMPLE 9 | 0 | YES | 4.0 | 0.9 | 4.44 | 0.51 | 0.9 |
| COMPARATIVE | 3 | — | 3.0 | 0.9 | 3.33 | 0.25 | 0.9 |
| EXAMPLE 1 | | | | | | | |
| COMPARATIVE | 1500 | — | 5.0 | 0.9 | 5.56 | 34.5 | 0.9 |
| EXAMPLE 2 | | | | | | | |
| COMPARATIVE | 30 | — | 2.0 | 0.9 | 2.22 | 1.30 | 0.9 |
| EXAMPLE 3 | | | | | | | |

| | | PRESENCE/ | | | | |
|---|---|---|---|---|---|---|
| | | ABSENCE | | | | |
| | | OF | EVALUATION | | | |
| | Ry | TRIPLE | | | ELECTROSTATIC | |
| | (Ly/Ln) | JUNCTION | LIFETIME | QUALITY | CAPACITANCE | QUALITY |
| EXAMPLE 1 | 2.56 | ABSENT | 252 | GOOD | 103 | EXCELLENT |
| EXAMPLE 2 | 12.44 | ABSENT | 702 | EXCELLENT | 104 | EXCELLENT |
| EXAMPLE 3 | 27.78 | ABSENT | 421 | EXCELLENT | 101 | EXCELLENT |
| EXAMPLE 4 | 31.89 | ABSENT | 268 | GOOD | 101 | EXCELLENT |
| EXAMPLE 5 | 0.38 | ABSENT | 108 | GOOD | 101 | EXCELLENT |
| EXAMPLE 6 | 3.03 | ABSENT | 152 | GOOD | 100 | GOOD |
| EXAMPLE 7 | 3.23 | ABSENT | 125 | GOOD | 100 | GOOD |
| EXAMPLE 8 | 2.56 | ABSENT | 117 | GOOD | 100 | GOOD |
| EXAMPLE 9 | 0.57 | PRESENT | 101 | GOOD | 101 | EXCELLENT |
| COMPARATIVE | 0.28 | ABSENT | 100 | GOOD | 100 | GOOD |
| EXAMPLE 1 | | | | | | |
| COMPARATIVE | 38.33 | ABSENT | 86 | POOR | 94 | POOR |
| EXAMPLE 2 | | | | | | |
| COMPARATIVE | 1.44 | ABSENT | 88 | POOR | 95 | POOR |
| EXAMPLE 3 | | | | | | |

As shown in Table 1, the multilayer ceramic capacitors according to the present embodiment had the ratio Ry of 0.3 or more and less than 35 and satisfied Expression I, and thus exhibited favorable lifetime and electrostatic capacitance. The multilayer ceramic capacitors of Examples 2 and 3 had the ratio Ry of 10 or more and less than 30 and satisfied Expression II, and thus exhibited particularly favorable lifetime. The multilayer ceramic capacitors of Examples 1 to 5 and 9 had the ratio Ra(0) of 3.0 or more and less than 6.0 and exhibited improvement of the electrostatic capacitance, which was favorable. In contrast, the multilayer ceramic capacitors of Comparative Examples 1 and 2 did not satisfy Expression I and exhibited inferior lifetime and/or electrostatic capacitance compared to the multilayer ceramic capacitors of Examples 1 to 9. The multilayer ceramic capacitors of Comparative Example 3 had the silicon content of less than 3 atomic % relative to the total amount of titanium elements and exhibited inferior lifetime and electrostatic capacitance.

According to an aspect of the present disclosure, a multilayer ceramic capacitor that exhibits excellent lifetime and electrostatic capacitance on the premise of low-temperature firing can be provided.

Although the embodiments have been described in detail above, the present disclosure is not limited to the above-described embodiments. Various changes, modifications, substitutions, additions, deletions, combinations, and the like can be made to the above embodiments within the scope of the appended claims.

Aspects of the present disclosure are, for example, as follows.

<1> A multilayer ceramic capacitor including:
an element body in which dielectric layers and internal electrode layers are alternately laminated in a first axis direction, in which
the dielectric layers include: ceramic particles containing a perovskite compound represented by a general formula ABO₃; silicon; and a rare-earth element,
the perovskite compound contains titanium,
an amount of the silicon is 3 atomic % or more relative to a total amount of the titanium, and
   the multilayer ceramic capacitor satisfies Expression I,

$$0.3 \leq Ly / Ln < 35 \qquad Expression I$$

where Ln is a distance (μm) between the internal electrode layers, and Ly is an average distance (nm) between the ceramic particles contained in a region where Ra(x)≥2Ra(0), in which Ra is a ratio of the amount of the silicon (atomic %) to an amount of the rare-earth element (atomic %), Ra(0) is an average value of Ra in the dielectric layers interposed between the internal electrode layers, and Ra(x) is a value of the Ra at a desired position in the dielectric layers interposed between the internal electrode layers.

<2> The multilayer ceramic capacitor according to <1>, in which the multilayer ceramic capacitor satisfies Expression II,

$$10 \leq Ly / Ln < 30. \qquad Expression II$$

<3> The multilayer ceramic capacitor according to <1> or <2>, in which the Ra(0) is 0.55 or more and less than 7.5.

<4> The multilayer ceramic capacitor according to <3>, in which the Ra(0) is 3.0 or more and less than 6.0.

<5> The multilayer ceramic capacitor according to any one of <1> to <4>, in which a triple junction is absent among the ceramic particles in a capacitance portion of the dielectric layers.

<6> The multilayer ceramic capacitor according to any one of <1> to <5>, in which the perovskite compound contains barium titanate.

What is claimed is:

1. A multilayer ceramic capacitor, comprising:
an element body in which dielectric layers and internal electrode layers are alternately laminated in a first axis direction, wherein
the dielectric layers include: ceramic particles containing a perovskite compound represented by a general formula ABO₃; silicon; and a rare-earth element,
the perovskite compound contains titanium,
an amount of the silicon is 3 atomic % or more relative to a total amount of the titanium, and
the multilayer ceramic capacitor satisfies Expression I,
$$0.3 \leq Ly / Ln < 35 \qquad Expression I$$
where Ln is a distance (μm) between the internal electrode layers, and Ly is an average distance (nm) between the ceramic particles contained in a region where Ra(x)≥2Ra(0), in which Ra is a ratio of the amount of the silicon (atomic %) to an amount of the rare-earth element (atomic %), Ra(0) is an average value of Ra in the dielectric layers interposed between the internal electrode layers, and Ra(x) is a value of the Ra at a desired position in the dielectric layers interposed between the internal electrode layers.

2. The multilayer ceramic capacitor according to claim 1, wherein
the multilayer ceramic capacitor satisfies Expression II,
$$10 \leq Ly / Ln < 30 \qquad Expression II$$

3. The multilayer ceramic capacitor according to claim 1, wherein
the Ra(0) is 0.55 or more and less than 7.5.

4. The multilayer ceramic capacitor according to claim 3, wherein
the Ra(0) is 3.0 or more and less than 6.0.

5. The multilayer ceramic capacitor according to claim 1, wherein
a triple junction is absent among the ceramic particles in a capacitance portion of the dielectric layers.

6. The multilayer ceramic capacitor according to claim 1, wherein
the perovskite compound contains barium titanate.
